(19) United States
(12) Patent Application Publication
(10) Pub. No.: US 2013/0203276 A1
(43) Pub. Date: Aug. 8, 2013

(54) LAMP SOCKET

(71) Applicant: Juergen Gerhard Mertens, Aachen (DE)

(72) Inventor: Juergen Gerhard Mertens, Aachen (DE)

(73) Assignee: KONINKLIJKE PHILIPS ELECTRONICS N.V., EINDHOVEN (NL)

(21) Appl. No.: 13/879,209

(22) PCT Filed: Oct. 7, 2011
(86) PCT No.: PCT/IB2011/054427

§ 371 Date: Apr. 12, 2013

(30) Foreign Application Priority Data
Oct. 18, 2010 (EP) 10187890.8

(51) Int. Cl. H01R 13/717; H01R 43/00

(52) U.S. Cl. CPC H01R 13/717; H01R 43/00
USPC 439/226; 29/592.1

(57) ABSTRACT

The invention describes a socket (1A, 1B) for a lamp (2), which socket (1A, 1B) comprises a socket wall (11) enclosing a cavity (12) between a socket rim (13) and a socket floor (14), which cavity (12) is dimensioned to partially accommodate the lamp (2); and at least one tab (3) for supporting the lamp (2) in the socket (1A, 1B), which tab (3) is arranged in the cavity (12) such that the tab (3) is secured in the body of the socket (1A, 1B) below the level of the socket rim (14); the tab (3) extends into the cavity (12) towards the socket rim (13); and an upper end of the tab (2) is arranged essentially at the level of the socket rim (13) or below the level of the socket rim (13). The invention further describes a method of mounting a lamp (2) in such a socket (1A, 1B), which method comprises the steps of positioning the lamp (2) in the cavity (12) such that a lamp contact area (20) is essentially at the level of the socket rim (13) and a tab contact area (30) lies against the corresponding lamp contact area (30); and bonding the tab contact area (30) to the lamp contact area (20). The invention also describes a lighting assembly (5) comprising such a socket (1A, 1B) and a lamp (2) mounted in the socket (1A, 1B) using such a method.

### FIELD OF THE INVENTION

The invention describes a socket for a lamp, a method of mounting a lamp in a socket, and a lighting assembly.

### BACKGROUND OF THE INVENTION

A gas discharge lamp such as a D-type high-intensity discharge (HID) lamp used to provide a very bright, near point light source is generally mounted in a socket which in turn is connected to a ballast. A discharge arc is generated in a small discharge chamber in an inner glass vessel, which in turn is shielded by an outer glass envelope. The purpose of the ballast is to provide the initially high starting voltage to ignite the lamp and to maintain the arc during normal operation. Lamps that are used in applications such as automotive front lighting must be secured very firmly in the socket, since a lamp in an automotive application may often be subject to vibration and shock. Even under such conditions, the lamp must provide a steady light source. In particular, any abrupt motion of the lamp relative to the socket should be avoided in order to avoid the discharge arc from being jolted, in which case it may ‘detach’ from an electrode so that the light is extinguished. For this reason, such lamps are generally fastened securely to the socket by means of a plurality of tabs which, at one end, are welded to a sleeve or cuff around the lamp, and are firmly anchored in the socket at the other end. To weld the tabs to the sleeve or cuff, a laser-beam welding (LBW) step is often used since this is precise and fast, allowing very accurate deposition of energy at the weld points of the tabs and sleeve. To accommodate the requirements of the LBW process, i.e. to allow a laser beam to be directed essentially perpendicularly at a weld point, the tabs of a prior art socket generally protrude some distance beyond the level of the socket rim. Here and in the following, the term “level of the socket rim” or “socket rim plane” is to be understood to mean the plane defined by the upper surface of the socket rim, whereby the upper surface of the socket rim is usually perpendicular to an optical axis of the lamp. Generally, the socket rim is a uniform and flat surface. For a socket rim with an uneven surface, an average level may be considered as a reference. The sleeve to which the tabs are to be connected is preferably located well down on the body of the lamp, i.e. in a region of the lamp relatively far away from the discharge chamber, so that it does not block any light. These considerations result in the centre of the discharge chamber of a prior art D-type HID lamp being located at about 27.1 mm from the socket rim. This is referred to as the ‘light-centre length’ (LCL) of the lamp. However, the long LCL of prior art lighting assemblies may be problematic, since the overall length of housing must accommodate such a long LCL, making such lighting assemblies unsuited for the more compact front lighting designs that are gaining in popularity.

It is therefore an object of the invention to provide a way of reducing the light-centre length of a lamp held in such a socket.

### SUMMARY OF THE INVENTION

This object is achieved by a socket according to claim 1, a method according to claim 7 of mounting a lamp in a socket, and a lighting assembly according to claim 13.

According to the invention, the socket for a lamp comprises a socket wall enclosing a cavity between a socket rim and a socket floor, which cavity is dimensioned to partially accommodate the lamp, and at least one tab for supporting the lamp in the socket, which tab is arranged in the cavity such that the tab is secured in the body of the socket below the level of the socket rim; the tab extends into the cavity towards the socket rim; and an upper end of the tab is arranged essentially at the level of the socket rim or below the level of the socket rim.

The tab of the socket according to the invention can be secured or anchored in the socket in any suitable manner such that the tab is secured at one (lower) end and oriented so that the other (upper) end is directed towards the level of the socket rim. Effectively, the entire tab or at least the greater part of the tab is located within the cavity of the socket, so that at most only a small portion of the tab protrudes out of the cavity beyond the level of the socket rim. An advantage of the socket according to the invention is that the light-centre length of the lamp can be favourably shortened without requiring any alterations to the lamp itself or any significant modifications of a lamp mounting process. This is because the greater part of the tab is essentially located below the level of the socket rim, while the upper end of the tab is used to support or secure the lamp in the socket. This is in contrast to a prior art socket with a tab extending outward from the level of the socket rim such that the greater part of the prior art tab is located above the socket rim. In the socket according to the invention, since the upper end of the tab does not extend beyond the socket rim to any significant extent, the level at which the tab is fastened to the lamp can be significantly lower than in the prior art solutions. With the inventive socket, the tab can be fastened to the lamp at a level even lower than the level of the socket rim.

According to the invention, the method of mounting a lamp in a socket—which socket comprises a socket wall enclosing a cavity between a socket rim and a socket floor, which cavity is dimensioned to partially accommodate the lamp, and which socket comprises at least one tab for supporting the lamp in the socket, which tab is arranged in the cavity such that the tab is secured near the socket floor, the tab extends away from the socket floor into the cavity towards the socket rim, and an upper end of the tab is arranged essentially at the level of the socket rim—comprises the steps of positioning the lamp in the cavity such that a lamp contact area is essentially at the level of the socket rim and a tab contact area lies against the corresponding lamp contact area; and bonding the tab contact area to the lamp contact area.

Since the region below which the tab is fastened to the lamp is uncritical as regards light output, as explained above, this portion of the lamp can be located within the cavity of the socket in the method according to the invention, without any detrimental effect on the light output.

According to the invention, the lighting assembly comprises such a socket and a lamp mounted in the socket using such a method. Therefore, the lighting assembly according to the invention can exhibit a favourably short light-centre length and can be used to advantage for automotive front lighting applications in which a compact lighting assembly design is desirable.

The dependent claims and the following description disclose particularly advantageous embodiments and features of the invention. Features of the embodiments may be combined as appropriate to arrive at further embodiments.

In an automotive application, the lamp is generally in a horizontal position in a lighting assembly. Light exiting the lamp body is collected and shaped by a reflector and/or a projection lens to give the desired beam shape. In the following, when describing the socket geometry, the floor of the socket is regarded as the base, and the socket wall, the tab and the lamp may be regarded as extending ‘outward’ or ‘upward’ from this base.

In the socket according to the invention, the tab can be secured in the body of the socket at any point below the level of the socket rim. For example, one of the tab can be anchored in the socket wall at some level between the socket rim and the floor of the socket. Alternatively, one end of the tab could be anchored in the socket floor itself. In a particularly preferred embodiment of the invention, however, one end of the tab is anchored essentially in the wall of the socket close to the socket floor.

The purpose of the tab is to secure the lamp firmly in an upright position with respect to the socket. Therefore, in a preferred embodiment of the invention, the upper end of a tab comprises a tab contact area, which tab contact area is shaped to lie against a lamp contact area arranged on the body of the lamp supported in the cavity. These contact areas can be fused or joined in a suitable manner, as will be explained below.

Usually, the contact areas will be joined by the application of heat, so that material of the lamp and tab contact areas can melt and fuse, giving a robust connection. Preferably, heat is applied to the contact areas without damaging the material of the socket. Therefore, in a further preferred embodiment of the invention, the socket comprises at least one recess or cut-out in the socket rim, which recess opens into the cavity and is arranged essentially in line with the tab contact area of a corresponding tab and a central axis of the lamp, i.e. in a sideward direction to the socket rim. In this way, the recess can offer a “line of sight” access to the tab contact area. Such a recess can be formed as a groove, notch or channel. Such a recess might extend over the entire width of the socket rim, or may commence at a point between the edges of the socket rim and extend towards the central axis to open into the cavity.

Since the upper end of a tab of the inventive socket is preferably located at or just below the level of the socket rim, the contact are of the tab may lie entirely below the level of the socket rim. The recess is preferably shaped to allow a source of heat energy to be directed at the contact area. Therefore, in a particularly preferred embodiment of the invention, the recess is arranged at an angle of inclination in the socket rim such that a lower end of the recess opens into the cavity, and wherein the angle of inclination comprises at most 30 degrees, more preferably at most 25 degrees, most preferably at most 20 degrees below the level of the socket rim. With such a favourably inclined recess, a source of heat energy can be directed into the cavity of the socket to strike the contact area of the tab essentially at a right angle or at an angle at least close to the perpendicular. This advantageously allows the heat to be deposited in an efficient manner.

The socket can be made of any suitable material. So that large numbers can be manufactured rapidly and with consistent quality, in a preferred embodiment of the invention the socket is made of a plastic material such as any suitable thermosetting or thermoplastic polymer suitable for an injection-moulding process, for example polyphenylene sulfide (PPS).

The tab is preferably made of a material that can be easily cut and shaped and which can be melted to fuse to a lamp contact area, for example a metal such as aluminium or steel. A suitable material can be sheet metal from which a tab can be punched, laser-cut or otherwise formed. A tab can be secured to a previously formed socket, for example by gluing, screwing, or otherwise anchoring one end of the tab close to the socket floor. However, in a particularly preferred embodiment of the invention, the tab is partially embedded in the socket during the injection moulding process. In this way, the tab is anchored particularly firmly in the socket and can therefore provide the lamp with the necessary stability, without requiring an additional fastening step.

The lamp is preferably held very securely in the socket so that, particularly for automotive applications, the lamp will remain firmly anchored in the socket even when subject to vibration or shock as the automobile passes over uneven ground. Therefore, in a particularly preferred embodiment of the invention, the socket comprises a plurality of tabs to hold the lamp. To facilitate fusing the contact areas, the socket also preferably comprises a corresponding plurality of recesses, wherein each recess is arranged in the socket rim essentially in line with the tab contact area of a corresponding tab and the central axis of the lamp.

To mount the lamp in the socket, as described above, the lamp is positioned in the cavity such that a lamp contact area is essentially at the level of the socket rim and a tab contact area lies against the corresponding lamp contact area. The tab contact area is then fastened in some way to the lamp contact area. For an automotive HID lamp, for example any D1-D5 lamp, the electrodes of the lamp are connected to a voltage supply or ballast on the other side of the socket floor. Therefore, to mount the lamp in the socket, one or more lamp parts are first inserted through corresponding openings in the socket floor. For example, a narrow cylindrical pinch tube of the outer envelope of the lamp, enclosing a first electrode lead, may be inserted through one opening in the centre of the socket floor. Another smaller opening in the socket floor can accommodate the second electrode lead, which is arranged parallel to the lamp's central axis, on the outside of the lamp outer envelope, to support the second electrode.

The tab could be fused or otherwise bonded to the lamp outer surface in any appropriate way. For example, solder could be applied at certain points on the lamp outer surface, or as a band along the outer circumference of the lamp, to act as lamp contact areas at the level of the socket rim. Once the lamp has been inserted onto the socket, heat can be applied to the tab contact areas to melt the solder and bond the contact areas. Any appropriate bonding technique could be used to fuse the tab and lamp contact areas, such as adhesive bonding, glass frit bonding, etc., depending on the material of choice for the tab and the preferred bonding process. Preferably, however, the bonding process is carried out in a similar manner to the established bonding process. Therefore, the method according to the invention preferably comprises arranging a sleeve around the outer surface of the lamp, which sleeve comprises a number of contact areas. The sleeve is preferably of the same material as the tab, so that the contact areas can fuse to give a satisfactory bond, for example steel or aluminium. Such a sleeve can also be formed of sheet metal, for example as a cuff or collar with a clip for holding it firmly in place. In the following, it may be assumed that such a sleeve is arranged around the lamp, so that a lamp contact area comprises an area on the sleeve that makes contact with the tab contact area. The area on the sleeve may therefore be referred to as a sleeve contact area in the following.

The step of bonding the tab contact area to the sleeve contact area preferably comprises welding the tab contact area to the sleeve contact area, since welding can ensure a very robust bond between the contact areas. During welding, the contact areas are heated to point at which the material of the tab/sleeve becomes molten. Once hardened, the contact areas are bonded or fused to give a robust connection.

Preferably, the step of welding the tab contact area to the sleeve contact area comprises a laser-welding step, since a beam of laser light can be directed with very high precision at the tab contact area (and therefore indirectly at the sleeve contact area on the other side of the tab contact area) and for very a precise duration. A pulsed laser can be used to apply a series of very short, intense energy pulses to very accurately heat the contact areas.

In laser beam welding (LBW), the beam is preferably directed at the tab contact area such that the beam strikes the tab contact area at an angle close to the perpendicular, i.e. in a frontal manner. Since the tab lies essentially entirely within the cavity of the socket according to the invention, however, the laser light beam must be directed at the tab contact area from above and at an angle. One way of ensuring that the laser beam strikes the tab contact area in an essentially frontal manner might be to design the sleeve in the manner of a flared ‘skirt’ so that the sleeve is wider at the bottom. With such a sleeve design, the tab contact area can present a surface that can be struck essentially at a right angle by the laser beam. However, as mentioned above, alterations to the established lamp manufacturing process are preferably avoided, and it may be preferred to leave the known sleeve design unchanged. Therefore, in a particularly preferred embodiment of the invention, the beam of laser light is directed at the tab contact area such that the path of the laser light beam lies at least partially within the corresponding recess. By allowing the laser beam to lie within the recess while being directed at the tab contact area, an optimal angle of incidence can be ensured for the LBW process, without having to make any alterations to the lamp sleeve design.

Preferably, the beam of laser light is directed at the tab contact area at an angle of at most 30 degrees, more preferably at most 25 degrees, most preferably at most 20 degrees. A laser light beam, directed in this manner at the tab contact area, can deposit energy favourably at the tab contact area, and therefore indirectly at the sleeve contact area, so that these can be satisfactorily fused.

As mentioned above, the lamp should be held very securely in the socket, particularly for an automotive front lighting application, in which the lamp and socket assembly may frequently be subject to vibration or shock. Therefore, in a particularly preferred embodiment of the invention, the socket comprises four recesses arranged in the socket rim such that each recess is essentially in line with the tab contact area of a corresponding tab and the central axis of the lamp, and which socket comprises four tabs laser-welded to four lamp contact areas on a sleeve of the lamp. Each of four tabs can therefore be fused to the sleeve of the lamp by laser-welding to give a particularly favourable robust assembly. Of course, three or even two tab/recess pairs may suffice, or it may be preferred to use more than four tab/recess pairs.

To absorb and distribute forces as evenly as possible, in a preferred embodiment of the invention the tabs are arranged essentially equidistantly in the cavity of the socket. For example, four tabs can be arranged with an angular separation of 90 degrees. If three tabs are used, these can be arranged with an angular separation of 120 degrees, etc.

Other objects and features of the present invention will become apparent from the following detailed descriptions considered in conjunction with the accompanying drawings. It is to be understood, however, that the drawings are designed solely for the purposes of illustration and not as a definition of the limits of the invention.

### BRIEF DESCRIPTION OF THE DRAWINGS

FIG. 1 shows a lighting assembly with a lamp mounted in a prior art socket;

FIG. 2 shows a socket according to a first embodiment of the invention;

FIG. 3 shows a socket according to a second embodiment of the invention;

FIG. 4 shows a cross-section of a lighting assembly according to an embodiment of the invention;

FIG. 5 shows a side view of the lighting assembly of FIG. 4.

In the diagrams, like numbers refer to like objects throughout. Elements of the diagrams are not necessarily drawn to scale.

### DETAILED DESCRIPTION OF THE EMBODIMENTS

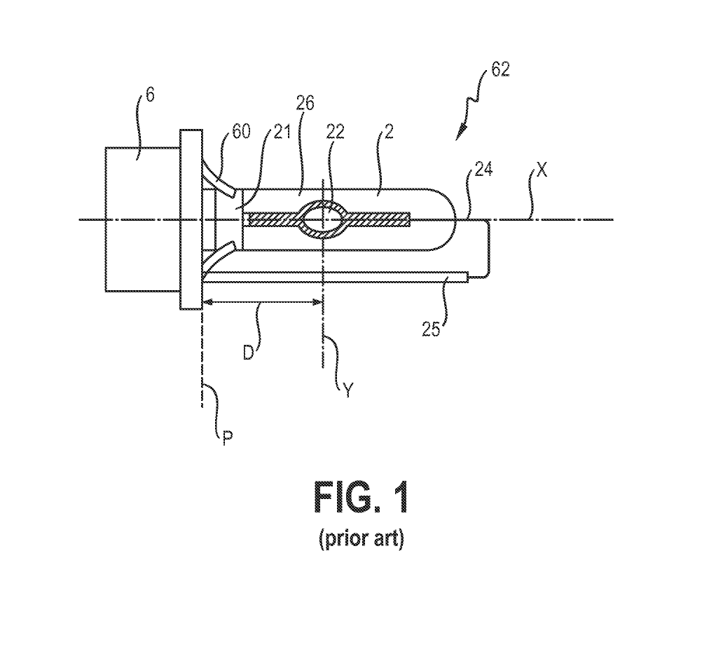

FIG. 1 shows a lighting assembly 62 with a lamp 2 mounted in a prior art socket 6. The lamp 2 comprises an inner discharge vessel 23 with a discharge chamber 22 in which a discharge arc is generated during operation. The inner discharge vessel 23 is enclosed in a protective outer vessel 26. Several tabs 60 are fixed in the socket 6 and arranged to lie against a sleeve 21 arranged around the outer circumference of the outer vessel 26. The sleeve 21 is located relatively far down on the outer vessel 26 to avoid any unnecessary loss of light. In this type of prior art socket 6, the positioning of the tabs 60 to protrude outward beyond the socket rim plane P 6 means that the light centre length D (measured between socket rim plane P and a vertical axis Y through the centre of the discharge chamber 22) is relatively large. Such a lighting assembly 62 requires a correspondingly ‘long’ housing when used in a front lighting application.

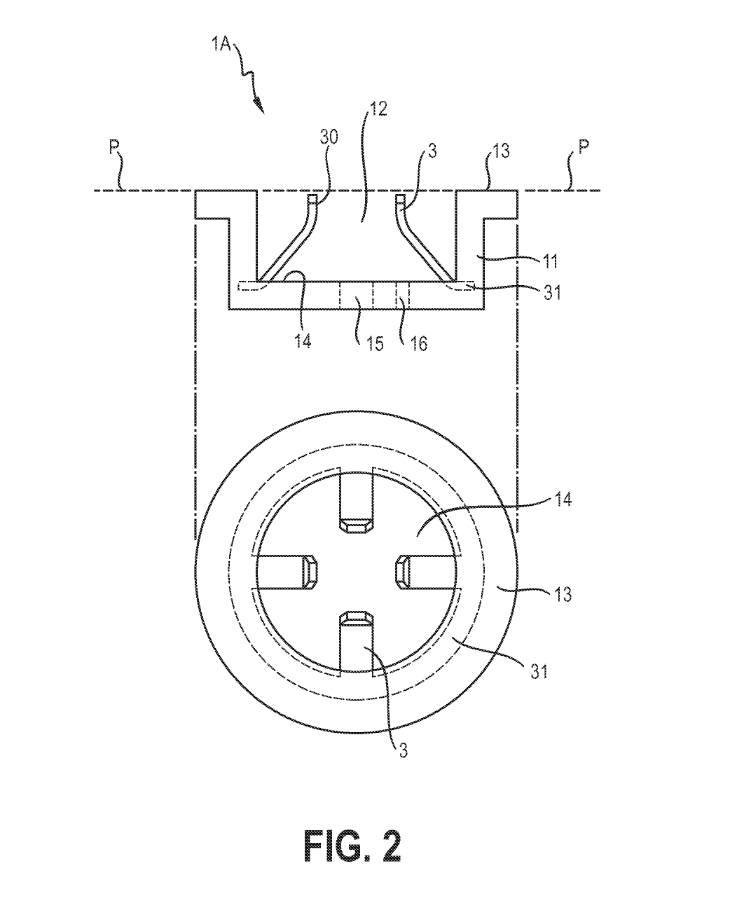

FIG. 2 shows a cross-section A-A′ through a socket 1A according to a first embodiment of the invention and a top view of the socket 1A. The socket 1A is circular in shape when viewed from the top, as shown in the top view in the lower part of the diagram. The cross-section A-A′ shows a cavity 12 defined by the socket wall 11 and the socket floor 14. A socket rim 13 is required for mounting the socket 1A onto a ballast (not shown). The cross-section shows two tabs 3 partially incorporated into the body of the socket 1A. The tabs 3 extend into the cavity 12 and to the level of the socket rim 13 or socket rim plane P. The top view shows a total of four tabs 3. These have been formed by punching the required shape—in this case a ring 31 with four flat tabs—from sheet metal, for example aluminium or steel. Prior to anchoring the sheet metal ring in the socket body in an injection moulding process, the tabs 3 are bent upward to the required degree. The ring 31 can then be completely enclosed by the plastic material of the socket leaving the tabs 3 exposed in the cavity 12.

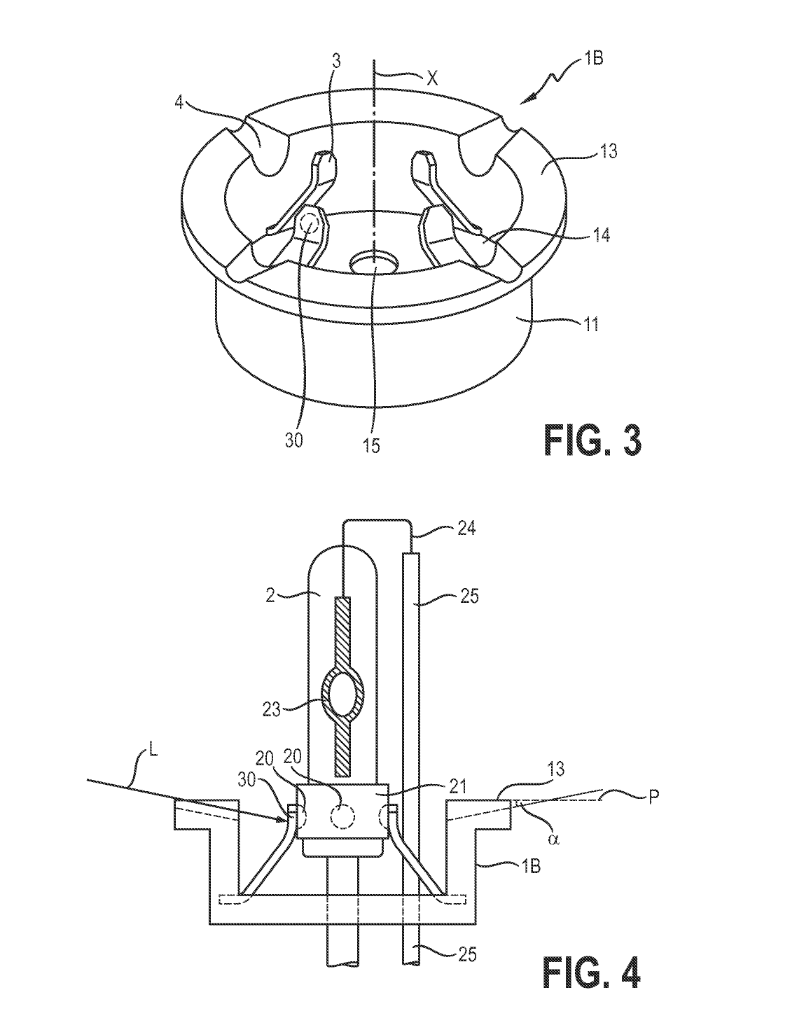

FIG. 3 shows a socket 1B according to a second embodiment of the invention, in which a number of channel-like recesses 4 have been formed in the wall of the socket 1B during the injection-moulding process. This diagram shows the orientation of four tabs 3 in the cavity 12 of the socket 1B. Each recess 4 is aligned with a tab contact area 30, so that a beam of laser light L can be directed along the recess 4 at the tab contact area 30. To accommodate the laser beam, each recess 4 is arranged at a downward angle into the cavity 12. An opening 15 in the socket floor 14 allows a lamp 2 to be inserted into the socket 1B, as indicated in FIG. 4, which shows a D-type HID lamp 2 being mounted in the socket 1B. A sleeve 21 is arranged around the circumference of the outer vessel 26 towards the base. A seal end 27 of the outer vessel 26, through which a first electrode passes, protrudes through the opening 15 in the base of the socket 1B. Another, smaller opening 16 allows a support for an isolating ceramic tube 25 for a second electrode 24 to pass through the socket floor 14. During mounting, the lamp 2 is made operational, so that a discharge arc is established in the discharge chamber 22. A camera (not shown) observes the position of this near point-sized light source in relation to a fixed reference (not shown), and the position of the lamp 2 is adjusted accordingly until a satisfactory position is obtained. Once the lamp's position is fixed, a beam of laser light L is directed at a tab contact area 20, at an angle to the horizontal plane P so that the laser beam L can be accommodated by the downward angled recess 4 through which it travels, to laser-weld it to a corresponding lamp contact area 30 on the sleeve 21. All four tabs 3 can be welded simultaneously with four separate laser beams, or the tabs 3 can be successively welded to the sleeve. Because the tabs 3 are located essentially within the socket 1B and do not protrude significantly above the socket rim 13 or socket rim plane P, the lamp 2 can be mounted considerably deeper in the socket 1B. As a result, the light-centre length of the lamp 2 in the socket lB according to the invention is smaller than for the prior art lamp shown in FIG. 1.

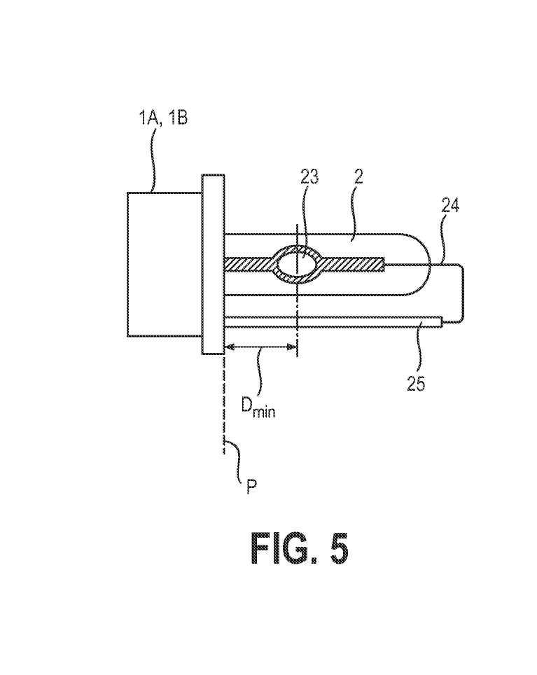

FIG. 5 shows a side view of a lighting assembly 5 according to the invention, in which a D-type HID lamp is mounted in the socket 1A, 1B. Compared to the prior art lighting assembly shown in FIG. 1, the tabs cannot be seen here, since they are set so low down in the socket 1A, 1B. Accordingly, the light centre length Dₘᵢₙ of this lighting assembly 5, measured between the socket rim plane P and a vertical axis Y through the discharge chamber 22, is favourably low, making it suitable for use in a shallow housing such as a compact housing for an automotive front lighting application.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art from a study of the drawings, the disclosure, and the appended claims. For example, instead of directing a laser light beam along a recess in the side wall of the socket to laser weld the contact areas, the socket wall might comprise a number of appropriately placed holes or vertical slits through which a laser light beam could be directed at a tab contact area.

For the sake of clarity, it is to be understood that the use of “a” or “an” throughout this application does not exclude a plurality, and “comprising” does not exclude other steps or elements. The mere fact that certain measures are recited in mutually different dependent claims does not indicate that a combination of these measures cannot be used to advantage. Any reference signs in the claims should not be construed as limiting the scope.

1. A socket for a lamp, which socket comprises a socket wall enclosing a cavity between a socket rim and a socket floor, which cavity is dimensioned to partially accommodate the lamp; and at least one tab for supporting the lamp in the socket, which tab is arranged in the cavity such that
the tab is secured in the body of the socket below the level of the socket rim;
the tab extends into the cavity towards the socket rim; and
an upper end of the tab is arranged essentially at the level of the socket rim or below the level of the socket rim; characterized in that the socket comprises at least one recess shaped to allow a source of heat energy to be directed at a tab contact area of a tab.

2. A socket according to claim 1, wherein the upper end of the tab comprises a tab contact area, which tab contact area is shaped to lie against a lamp contact area of the lamp supported in the cavity.

3. A socket according to claim 2, comprising at least one recess in the socket rim, which recess opens into the cavity and is arranged essentially in line with the tab contact area of the tab and a central axis of the lamp.

4. A socket according to claim 3, wherein the recess is arranged at an angle of inclination (α) in the socket rim such that a lower end of the recess opens into the cavity, and wherein the angle of inclination (α) comprises at most 30 degrees, more preferably at most 25 degrees, most preferably at most 20 degrees below the level of the socket rim.

5. A socket according to claim 1, wherein the tab is partially embedded in the socket.

6. A socket according to claim 1, comprising a plurality of tabs and a corresponding plurality of recesses, wherein each recess is arranged in the socket rim essentially in line with the tab contact area of a corresponding tab and the central axis of the lamp.

7. A socket according to claim 1, wherein the tabs are arranged essentially equidistantly in the cavity of the socket.

8. A method of mounting a lamp, in a socket, which socket comprises a socket wall enclosing a cavity between a socket rim and a socket floor, which cavity is dimensioned to partially accommodate the lamp; and which socket comprises at least one tab for supporting the lamp in the socket, which tab is arranged in the cavity such that
the tab is secured in the body of the socket below the level of the socket rim;
the tab extends into the cavity towards the socket rim; and
an upper end of the tab is arranged essentially at the level of the socket rim or below the level of the socket rim;
and at least one recess shaped to allow a source of heat ener to be directed at a tab contact area of a tab;
which method comprises the steps of
positioning the lamp in the cavity such that a lamp contact area is essentially at the level of the socket rim and a tab contact area lies against the corresponding lamp contact area; and
directing a source of heat energy along a recess at a tab contact area of a tab to bond the tab contact area to the lamp contact area.

9. A method according to claim 8, comprising the step of arranging a sleeve around the outer surface of the lamp, which sleeve comprises a number of lamp contact areas.

10. A method according to claim 8, wherein the step of bonding the tab contact area to the lamp contact area comprises welding the tab contact area to the lamp contact area.

11. A method according to claim 10, wherein the step of welding the tab contact area to the lamp contact area comprises a laser-welding step, wherein a beam of laser light is directed at the tab contact area such that the path of the laser light beam lies at least partially within a corresponding recess arranged in the socket rim.

12. A method according to claim 11, wherein the beam of laser light (L) is directed at an angle of at most 30 degrees, more preferably at most 25 degrees, most preferably at most 20 degrees at the tab contact area.

13. A lighting assembly comprising a socket according to claim 7.

14. A lighting assembly according to claim 13, wherein the socket comprises four tabs and four recesses arranged in the socket rim such that each recess is essentially in line with the tab contact area of a corresponding tab and the central axis (X) of the lamp, and wherein the tabs are laser-welded to lamp contact areas on a sleeve of the lamp.

15. A lighting assembly according to claim 13, comprising a D-type high-intensity discharge lamp mounted in the socket, wherein the distance (Dₘᵢₙ) between the centre of a discharge chamber of the lamp and the level of the socket rim comprises at most 18 mm.
